(19) United States
(12) Patent Application Publication
(10) Pub. No.: US 2022/0022481 A1
(43) Pub. Date: Jan. 27, 2022

(54) APPARATUS AND METHODS FOR PROCESSING COFFEE GROUNDS

(71) Applicant: Groundup Eco-Ventures Ltd., Okotoks (CA)

(72) Inventor: Shawn Patrick LEGGETT, Okotoks (CA)

(21) Appl. No.: 17/383,751

(22) Filed: Jul. 23, 2021

Related U.S. Application Data
(60) Provisional application No. 63/056,069, filed on Jul. 24, 2020.

(51) Int. Cl. A23F 5/48; A23F 5/10; A21D 2/36; A23F 5/16; A23N 12/08; C11B 1/10

(52) U.S. Cl. CPC A23F 5/483; A23F 5/10; C11B 1/104; A23F 5/166; A23N 12/083; A21D 2/36

(57) ABSTRACT

A method of processing coffee grounds. The method includes drying coffee grounds to at least a predetermined dryness by using a rotatory drier to heat and agitate the grounds while measuring the dryness of the drying coffee. After the coffee grounds have been dried, they are mixed with supercritical CO₂ to separate liquid components of the coffee grounds from solid components. This provides a simple, safe way of extracting coffee oil and producing coffee flour.

### RELATED APPLICATIONS

This application claims 35 USC 119 priority to U.S. Provisional Patent Application No. 63/056,069 filed Jul. 24, 2020, which is hereby incorporated by reference in its entirety.

### FIELD OF THE INVENTION

The invention relates to processing coffee grounds to extract oils and/or to condition the solids.

### BACKGROUND

Brewed coffee is made mixing water with ground coffee beans (typically at high temperature and pressure), then allowing to brew. The brewed coffee is then separated from the coffee grounds for drinking. The coffee grounds may then be discarded.

In gardens, coffee grounds may also be used for composting or as a mulch as they are known to slowly release nitrogen into the soil. The dry coffee grounds contain significant amounts of potassium (11.7 g/kg), magnesium (1.9 g/kg), and phosphorus (1.8 g/kg).

The most-common method to extract the oils in coffee grounds is to mix the grounds with the solvent hexane and then heat the mixture at 60° C. for 1-2 hours to extract the oils. The hexane is evaporated to leave behind the oils.

Hexanes are colorless hydrocarbons which are liquids at room temperature and pressure, odorless when pure, with boiling points between 50 and 70° C. Hexanes are widely used as cheap, non-polar solvents.

Liang Jin et al. (“Study on capacity of coffee grounds to be extracted oil, produce biodiesel and combust”, Energy Procedia 152 (2018) 1296-1301) describe how, in order to reuse coffee grounds, the n-heptane was used to extract the coffee oil from spent coffee grounds. Then the coffee oil and methanol were used to prepare biodiesel through transesterification. In addition, the coffee grounds after extraction of oil was used to make solid biofuels. By experiments, the effects of different extraction methods, different proportions of n-heptane and coffee grounds, number of repeated uses of n-heptane and moisture content of raw materials on extraction rate of coffee oil and recovery of n-heptane were determined.

Z. Al-Hamamre et al. (“Oil extracted from spent coffee grounds as a renewable source for fatty acid methyl ester manufacturing”, Fuel 96 (2012) 70-76) investigates the effect of different extraction solvents (polar and non-polar) on yield, chemical and physical properties, including free fatty acid content (FFA) or acid value (AV), saponification value (SV), density, viscosity, elemental composition and heating values of oil extracted from spent coffee grounds (SCG). The solvents investigated are: hexane, pentane, toluene, chloroform, ethanol, isopropanol and acetone.

U.S. 2017/325,474 discloses a method for moist extraction of oil-containing components from coffee beans and/or residues from coffee production, wherein the coffee beans and/or residues from coffee production with a residual moisture content of 10 to 95 percent by mass, measured with reference to the total mass of the coffee beans and/or residues from coffee production, are extracted using a mixture of extraction agents consisting of at least one polar solvent (e.g. alcohol) and one nonpolar solvent (e.g. gasoline, kerosene, toluene, an alkane), and wherein the mixture of extraction agents contains the at least one nonpolar solvent in a percentage of 45 to 95 vol %, measured with reference to the total volume of the extraction agent.

### SUMMARY

In accordance with the invention, there is provided a method of processing coffee grounds comprising:

drying coffee grounds to at least a predetermined dryness by using a rotatory drier to heat and agitate the grounds while measuring the dryness of the drying coffee; and

mixing the dried coffee grounds with supercritical CO₂ to extract liquid components of the coffee grounds from solid components.

The dried coffee grounds may contain 12% water or less by weight. The dried coffee grounds may contain 11% water or less by weight. The dried coffee grounds may contain 5% water or less by weight. The dried coffee grounds may contain between 2-5% water by weight. A lower water content may help facilitate the extraction process. However, drying excessively (e.g. below 1% water by weight) may be energy intensive, take time, and may start to evaporate or damage valuable liquid components before the extraction step.

The coffee grounds may be dried at a temperature of between 135° F. and 155° F. (55-70° C.) for pasteurization and drying. The coffee grounds may be dried at a temperature of between 145° F. and 175° F. (63-80° C.). Drying at a temperature of 145° F. or higher ensures that the grounds are pasteurized. Drying at a temperature below 175° F. helps prevent unwanted oxidation of the oils. Also, dehydrating at a high temperature can influence the taste of the by-product (coffee flour), giving it an unpleasant taste.

The rotary drier may comprise a rotating drum to contain the coffee grounds.

The rotary drier may comprise rotating agitators which rotate within a drum configured to contain the coffee grounds.

The rotary drier may utilize heated air to a pre-determined temperature

The rotary drier may comprise rotating auger which rotate within a drum to agitate and more effectively dry the coffee grounds.

The dryness may be measured by a humidity sensor mounted in an extraction outlet of the drier.

The dryness may be measured by measuring the water activity of the grounds. The drier may be configured to reduce the water activity to below a predetermined level (e.g. 0.3) before extraction.

Water activity (a_{w}) is the partial vapor pressure of water in a solution divided by the standard state partial vapor pressure of water. In the context of this disclosure, the standard state is the partial vapor pressure of pure water at the same temperature.

Water activity values may be obtained by either a resistive electrolytic, a capacitance or a dew point hygrometer.

The dried coffee grounds may be directly placed in the extraction vessel from the drier (i.e. without an intermediate processing step, such as further milling or sifting).

The method may comprise grinding coffee grounds to predetermined size between 200 μm and 250 μm. This may be done before or during drying. The dehydrating equipment may be configured to reduce the particle size of the drying coffee grounds.

The method may comprise sifting the solid coffee grounds after extraction to produce coffee grounds flour.

The fluid may comprise oil, waxes and saponification fluids.

The temperature of the supercritical CO₂ may be between 31 and 160° C.

The pressure of the supercritical CO₂ may be between 71 and 340 atm. The pressure of the supercritical CO₂ may be between 280 and 320 atm. The pressure of the supercritical CO₂ may be between 71 and 400 atm.

The pressure and temperature of the supercritical CO₂ may be adjusted to extract different fractions of the liquid components at different times.

Dried coffee grounds may be mixed with supercritical CO₂ for between 1-10 hours.

The dried coffee grounds may be soaked in liquid CO₂. This may speed up the extraction process. The dried coffee grounds may be soaked in liquid CO₂ for an hour (e.g. between 30 minutes and 5 hours). The soaking may take place prior to extraction with supercritical CO₂. The liquid CO₂ used for soaking may be converted to supercritical CO₂ by adjusting the temperature and/or pressure. Alternatively, or in addition, the liquid CO₂ may be removed and replaced by supercritical CO₂.

The method may be performed in batches of between 1-130 kg of coffee grounds.

The method may be performed in batches of between 10-150 kg of coffee grounds.

Spent coffee grounds are the waste product from brewing coffee, in the final stages of coffee preparation. Spent coffee grounds may be considered to be the remains of granules of ground coffee beans which have had water-soluble components removed (e.g. by brewing). In contrast, ground coffee may be considered to be the granules of coffee beans which have not had water-soluble components removed (e.g. before brewing).

Supercritical CO₂ is CO₂ at a temperature above the critical temperature (31° C.) and a pressure above the critical pressure (about 73 atmospheres). Supercritical CO₂ is a single-phase fluid state of CO₂.

The solubility of many extracted compounds in CO₂ varies with pressure, permitting selective extractions.

The temperature of the extraction step may be in one or more of the following ranges: 31-80° C.; 80-120° C. and 120-160° C. The pressure of the extraction step may be greater than 80 atmospheres.

Flour may be considered to be a material with a size distribution such that at least 90% of the material by weight would pass through a 212-μm sieve (US Standard Mesh No. 70).

According to a further aspect, there is provided an apparatus for processing coffee grounds comprising:

a rotary drier configured to receive coffee grounds, the rotatory drier comprising:
a heater configured to heat the received coffee grounds;
a heated air pump to circulate the grounds;
a rotary agitator configured to agitate the received coffee grounds; and
a sensor configured to measure the dryness of the received coffee grounds during drying;

wherein the rotary drier is configured to dry the received coffee grounds to at least a predetermined dryness; and

a supercritical CO₂ extraction assembly comprising:
an extraction vessel configured to receive the dried coffee grounds from the rotary drier;
a source of CO₂;
a heater and a pump configured to condition the CO₂ received from the CO₂ source to be in a supercritical state within the vessel; and
an outlet for extracting liquid components of the coffee grounds from the n extraction vessel.

The apparatus may comprise a grinder for grinding or milling spent coffee grounds to the desired consistency.

Pasteurization is a process in which foodstuffs are treated with mild heat, usually to less than 100° C. (212° F.), to eliminate pathogens and extend shelf life. The process is configured to destroy or deactivate organisms and enzymes that contribute to spoilage or risk of disease, including vegetative bacteria.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a schematic diagram of the apparatus used to carry out the extraction of oil from coffee grounds.

FIG. 2 is a flow chart showing how coffee grounds are processed to extract liquid components and to produce coffee flour.

### DETAILED DESCRIPTION

### Introduction

Brewed coffee is made mixing water with ground coffee beans (typically at high temperature and pressure), then allowing to brew. There are several methods for doing this, including using a filter, a percolator, and a French press. Terms used for the resulting coffee often reflect the method used, such as drip brewed coffee, filtered coffee, pour-over coffee, immersion brewed coffee etc. Water seeps through the ground coffee, absorbing its constituent chemical compounds, and then passes through a filter. The used coffee grounds are retained in the filter, while the brewed coffee is collected in a vessel such as a carafe or pot.

The coffee grounds are typically then discarded, or used directly, for example, as garden mulch. However, the coffee grounds typically retain valuable products which may be extracted and used. These include the liquid components of the grounds which were not extracted by the brewing process (e.g. oil, waxes and saponification fluids) and the remaining solid materials.

Spent coffee grounds contain approximately 10-15% by weight of oil. The main fatty acid constituents are palmitic, linoleic, oleic, stearic and arachidic1. Spent coffee grounds also contain phenolic compounds including chlorogenic acid, caffeoylquinic acid, dicaffeylquinic acid, feruloylquininc acid and p-coumarolyquinic acid.

Typically, the extraction process used to extract liquid components from coffee grounds involve the use of hexane (a non-polar liquid hydrocarbon solvent).

The inventors have realized that by combining drying a rotary drier with super-critical CO₂ extraction, improved extraction results may be obtained. Advantages of the present invention may include:
the products have fewer pathogens: the rotary drier ensures that the grounds are dried evenly to kill off pathogens. Remaining pathogens would be killed by the super-critical CO₂.
The products have fewer dangerous chemicals present: Because CO₂ is a gas at room temperature it automatically is evaporated from the products (unlike, for example, hexane or toluene).
The extraction fluid can be easily recycled: Again, because CO₂ is a gas at room temperature it can easily be removed, captured and recycled for further extractions.
The CO₂ extraction stage is more effective when the grounds are dried in a rotary drier: By agitating and mixing the grounds as they dry, clumps or crusts of coffee grounds do not form (e.g. as may be the case using oven drying in trays). This helps ensure that the humidity measurements are more accurate, and that the super-critical CO₂ is able to access the liquids within the grounds more easily.
The remaining solids are produced in a useful flour form: the super-critical CO₂ extraction step aids in forming the coffee grounds to form into a flour, which can then be used directly after sifting without further milling.
Utilizing our technology, we eliminate a specific waste stream from the coffee industry, spent coffee grounds.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### Apparatus

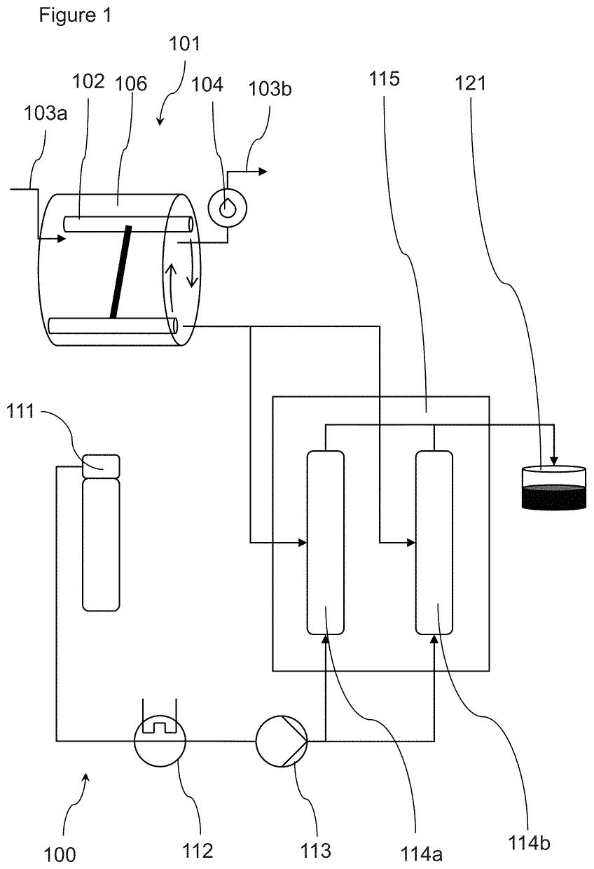

FIG. 1 shows a schematic of an apparatus 100 for extracting liquid components from coffee grounds. The apparatus is configured to take used coffee grounds and first dry them using a rotary drier, and then extract liquid components using super-critical CO₂. In some embodiments, the dried grounds are milled or further ground before the extraction phase

### Drying

As shown in FIG. 1, the dryer 101 comprises a drum 106 and a rotating agitator 102. The rotating agitator rotates within the drum to mix the coffee grounds to prevent them forming clumps or a crust, and to ensure that they are evenly dried. The rotating agitator sweeps out substantially the entire volume of the cylindrical drum to ensure that all the grounds contained in the drum are moved during a rotation cycle. Evenly drying the coffee grounds also ensures that the humidity measurements are more accurate. That is, they are representative of all the grounds within the dryer, rather than just the portions closest to the humidity meter. In this case the rotation axis of the rotary drier is aligned with the horizontal.

In this case, the drier utilizes heat and agitation to keep the grounds moving. This movement also creates airflow. Airflow in this case, is also provided by cycling air into the drier through air inlet 103a and out of the drier (along with evaporated water) through air outlet 103b. This ensures proper drying as well as eliminating pathogens. Using heat and agitation allows the grounds to be dried and pasteurized in one step. The drier is configured to ensure a moisture content below 11% which helps ensure that there are no pathogens in the dried grounds. In this case, the humidity of the grounds can be measured by measuring the humidity of the air passing through the air outlet 103b using a humidity sensor 104. In other embodiments, the dryness of the grounds is measured in terms of the water activity, and the drier is configured to ensure a water activity of less than a predetermined threshold (e.g. 0.3).

Commercial dehydrators are unable to dehydrate and pasteurize in one step, requiring a second step and an increase in power usage and cost. Dehydrating alone can leave bacterial compounds behind, leading to salmonella poisoning. The temperatures used in the present technology enable pasteurization.

Agitating the grounds as they dry ensure that the grounds dry evenly and do not form clumps or aggregates of coffee grounds stuck together. It is important that the granular structure of the grounds is maintained so that, in the extraction step, the supercritical CO₂ can access the liquid components of the grounds. Extraction is a diffusion-based process, in which the solvent is required to diffuse into the matrix and the extracted material to diffuse out of the matrix into the solvent. Reducing the distance by maintaining the granular structure of the grounds may significantly speed up the time required to extract the liquid components from the grounds. In contrast, if the grains of coffee grounds form a solid superstructure (e.g. clumps or a crust), the supercritical CO₂ extraction step may be much slower.

Experiments by the inventors have established that the technology can dry the coffee grounds to a moisture content of less than 11% and be pathogen free.

Once the coffee grounds are dried and pasteurized, they are placed in an extraction vessel for supercritical CO₂ extraction. In some embodiments, the dried grounds are directly transmitted to the extraction vessel. Limiting exposure to the atmosphere may help prevent the coffee grounds reabsorbing water from the atmosphere and or capturing new pathogens.

### Extraction

Once the spent coffee grounds are dry, supercritical CO₂ extraction is used to remove the oil, waxes and saponification fluids (triglycerides) from the cellular walls of the coffee grounds. This process also helps pulverize the solid components of the coffee grounds into particles that have the consistency of flour. This means that the solids only need to be mechanically sifted to separate a saleable flour product. That is, the remaining solids may be sifted directly after the supercritical CO₂ extraction to form the flour (e.g. without an intermediate grinding step).

To perform an extraction, the dried coffee grounds are placed into an extraction vessel 114a and/or 114b. In this case, the system has multiple extraction vessels which allow the system to operate continuously, while each vessel operates as a batch process.

In this case, CO₂ gas is introduced into the extraction vessel 114a, 114b from a CO₂ source vessel 111. In this case, the gas from the source vessel is first cooled using a cooler 112, then pumped into the vessel 114a,b using a pump 113. The temperature within the vessel 114a,b is controlled by placing the vessels within an oven 115 which can be heated and cooled as required. The conditions of temperature and pressure within the extraction vessels are controlled by controlling the pressure of the pump 113 and the temperature of the oven 115. These conditions are controlled to force supercritical CO₂ into the extraction vessel where it interacts with the coffee grounds, where it dissolves part of the coffee grounds. These dissolved components are the extracted liquid components 121. When the pressure is reduced on the extracted liquid components 121, the CO₂ turns to gas and can be recycled.

By changing the temperature and pressure as well as flow rate, certain molecules will bond to CO₂, allowing them to be separated from the coffee grounds. Circulating CO₂ at pressures of around 4300 psi (e.g. between 3900 psi to 4400 psi, or between 26.5 MPa to 28.5 MPa) and temperatures of around 55° C. (e.g. between 40-65° C.) extracts the oils, waxes, and saponification of fatty acids. For example, the extraction may take place at 4350 psi and 120° F. (50° C.). As the CO₂ travels through the coffee grounds it liberates these components from the cell walls of the spent coffee grounds.

This process also reduces the grain size of the spent coffee grounds to a consistency common with flour. This reduces the need to mill the flour, reducing both costs and power usage.

In this embodiment, once the CO₂ is released from the solute, it is recycled back into the tank to be used during the next batch.

By using supercritical CO₂, the user has control over the procedure, CO₂ can be recycled, making this method more environmentally friendly compared to others. Further, regulatory authorities, such as the U.S. Federal Drug Administration (FDA), consider CO₂ safe for industrial extractions. Although the drying process in this embodiment provides a pathogen-free starting product for the extraction, the CO₂ may also act as a cleaning agent by removing remaining microbial bacteria, molds, and mildews. The yield using supercritical CO₂ is typically higher than other extraction methods; however, the yield and quality of product is sensitive to changes in the physical properties of the starting material. The inventors have found that using a rotary drier to agitate the raw grounds while drying provides a more consistent starting material for the extraction process.

Extracts obtained from supercritical CO₂ extraction are appealing to the food and beverage and medical industries, because no residual solvent will remain on the product at room temperature and pressure (because CO₂ is a gas under these conditions). Because there is no residual solvent on the product, the extract will be purer than many solvent-based extraction methods. For example, because the most-commonly used solvent, hexane, is a liquid at room temperature, The grounds need to be dried prior to the extraction process and need to be dried again to be utilized for anything else. The system uses a lot of energy and also uses a hydrocarbon to create the oil. The typical drying process is also not enough to kill all pathogens, meaning there is a chance you still have bacteria in the grounds which may lead to salmonella poisoning. In addition, recycling of hexane is limited because typically only 60% of the hexane can be recaptured in a cooling tower.

### Sifting

As noted above, supercritical CO₂ extraction causes the solid components of the grounds to break up into a material with the consistency of flour. This flour can be separated using a simple mechanical sifter to produce a saleable flour product (e.g. using 200 or 212 micron mesh). That is, no further mechanical milling is required. This may significantly reduce operation costs. The flour component may be greater than 70% of total solids by weight.

### Method

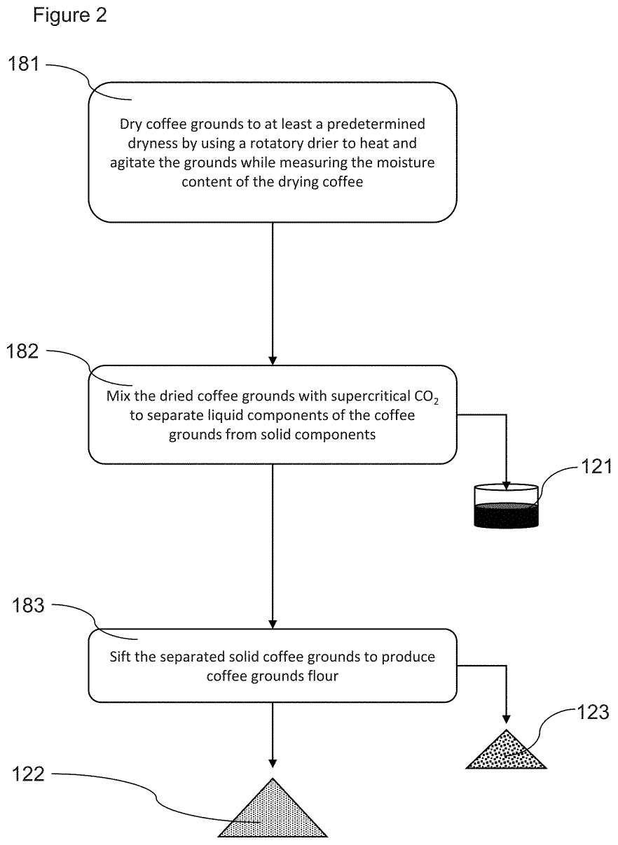

FIG. 2 is a flow chart showing how coffee grounds are processed to extract liquid components and to produce coffee flour (e.g. using the apparatus of FIG. 1).

The method comprises drying 181 coffee grounds to at least a predetermined dryness by using a rotatory drier to heat and agitate the grounds while measuring the dryness of the drying coffee.

Then, the dried coffee grounds are mixed 182 with supercritical CO₂ to separate liquid components 121 of the coffee grounds from solid components.

The separated solid coffee grounds are then sifted to produce coffee grounds flour 122 and a coarser-grained solids 123.

### End Products

The end products are safe for consumption. For example, the coffee oil can be used in the pharmaceutical, cosmetic, food industry and textile industry.

Coffee oil may be used as a high quality and cost-effective feedstock for biodiesel production compared to other waste sources. It is less expensive, has higher stability (due to its high antioxidant content), and has a pleasant smell.

The sifted coffee flour may be used in baking as a substitute or partial replacement for wheat flour. Coffee flour does not contain gluten, and so can be safely consumed by gluten-intolerant individuals. Coffee flour may also be a source of fiber, minerals (e.g. magnesium) and/or antioxidants.

### Experimental Results

A 3-day trial of 3 extractions at varied pressures and temperatures utilizing a total of 120 L of spent coffee grounds was conducted. Extraction #1 was conducted at 200 bar (197 atm) and 50° C., extraction #2 was performed at 300 bar (296 atm) and 50° C., and extraction #3 was conducted at a pressure of 350 bar (345 atm) and 58° C. All three tests gave different results, extraction #1 provided a slightly higher ratio of extracted material. However, extraction #2 gave a greater portion of the more valuable dark coffee oil fraction. This illustrates that the reaction conditions can be tailored to control the materials extracted.

A Vitalis™ Q90H was used for all three extractions. One extraction chamber was filled with spent coffee grounds dried to less than 10% moisture content and ground to approximately <1 mm. Both cyclone and separator series were used for collection to maximize flow rate. For each extraction, total percent mass extracted was calculated using the following formula:

Total percent mass extracted=Total mass extracted×100/Total feedstock input mass

The average extraction results for each run are shown in Table 1. How the extraction proceeds over time is shown in Table 2. These values were obtained using the batch data from the HMI recorded during the runs. Extraction 1 and its associated parameters produced an extraction yield of 15.79% after 7 hours. Extraction 2 yielded significantly more in the first hour than the other two extractions. This may be due in part to the 1-hour soaking time before starting the run. Extraction 3 with the highest pressure and temperature yielded the lowest of the three runs.

Andrade et al. states that the effect of temperature, at constant pressure, occurs by two mechanisms. Firstly, the increase in temperature increases the solubility due to increased vapor pressure of the solute. Conversely, it reduces the solubility due to the decrease in density of the solvent. These two opposite effects result in the crossover of the isotherms and decrease the strength of the solvent. This helps explain the lower extraction yield shown in Extraction 3. The extract separated into layers with different amounts being extracted at different times depending on the parameters for that extraction run.

Visual inspection of the extracted material indicates that there are multiple distinct layers. The ratio of the size of the layers is different for different extraction conditions. Analytic results of one of the extractions showing the variety of compounds extracted are shown in Table 3.

TABLE 1
Extraction Results

| | Extraction 1 | Extraction 2 | Extraction 3 |
|---|---|---|---|
| Average Extraction | 2901.14 | 4302.99 | 4508.68 |
| Pressure (psi) | | | |
| Average Extraction | 118.98 | 121.25 | 131.11 |
| Temperature (F) | | | |
| Average Cyclone | 55.77 | 55.13 | 56.26 |
| Temperature (F) | | | |
| Average Flow Rate (kg/min) | 3.01 | 2.95 | 2.45 |
| Total CO₂ Mass (kg) | 1264.20 | 1062.00 | 882.00 |

TABLE 2
Cumulative Extracted Mass

| | Extraction 1 | Extraction 2 | Extraction 3 |
|---|---|---|---|
| Feedstock Input Mass | 18432.2 g | 18141.4 g | 17980.4 g |
| 1 hr | 469.7 g | 966.0 g | 609.2 g |
| 2 hr | 889.9 g | 1454.2 g | 1113.2 g |
| 3 hr | 1561.1 g | 1925.8 g | 1597.0 g |
| 4 hr | 2082.3 g | 2329.4 g | 1931.4 g |
| 5 hr | 2477.3 g | 2621.0 g | 2131.8 g |
| 6 hr | 2743.7 g | 2751.4 g | 2385.8 g |
| 7 hr | 2910.5 g | — | — |
| Total Percent Mass | 15.79% | 15.17% | 13.27% |
| Extracted | | | |

TABLE 3
Analytical Testing Results for 300 bar and 50° C.

| Component | Heavy | Medium | Light |
|---|---|---|---|
| C10:0 Capric | 0.3 | <0.03 | n/a |
| C12:0 Lauric | 0.41 | <0.03 | <0.03 |
| C14:0 Myristic | 0.27 | 0.09 | 0.1 |
| C15:0 Pentadecanoic | n/a | 0.03 | 0.04 |
| C16:0 Palmitic | 32.5 | 36.1 | 37.2 |
| C16:1Tn7 Trans | n/a | 0.33 | 3.15 |
| Palmitelaidic | | | |
| C16:1n7 Palmitoleic | 0.18 | 0.03 | 0.04 |
| C17:0 Heptadecanoic | n/a | 0.33 | 0.14 |
| (Margaric) | | | |
| C18:0 Stearic | 8.7 | 7.97 | 7.19 |
| C18:1n9 Oleic | 7.52 | 7.38 | 6.84 |
| C18:1Tn9 Trans | n/a | 0.07 | 0.63 |
| Elaidate | | | |
| C18:1n7 Vaccenate | 0.43 | 0.5 | 0.51 |
| C18:2n6 Linoleic | 40 | 39.2 | 35.3 |
| C18:2Tn6 Trans | n/a | 0.06 | 0.56 |
| Linoelaidate | | | |
| C18:3n3 Aplha- | 1.45 | 1.35 | 1.22 |
| Linolenic | | | |
| C18:4n3 | n/a | 0.09 | 0.07 |
| Octadecateraenoic | | | |
| C19:0 Nonadecanoic | n/a | 0.09 | 0.07 |
| C19:1Tn12 Trans | 0.16 | 0.22 | 2.05 |
| Nonadecanoate 7 | | | |
| C20:0 Arachidic | 3.8 | 3.5 | 2.88 |
| C20:1n9 Eicosenoic | 0.34 | 0.38 | 0.4 |
| 11 | | | |
| C20:1Tn9 Trans | n/a | 0.05 | 0.25 |
| Eicosenoate 11′ | | | |
| C20:2n6 | <0.03 | 0.07 | 0.06 |
| Eicosadienoic 11, 14 | | | |
| C20:5n3 | n/a | n/a | <0.03 |
| Eicosapentaenoic | | | |
| C22:0 Behenic | 2.16 | 1.48 | 0.74 |
| C22:1n9 Erucic | n/a | <0.03 | 0.06 |
| C22:2n6 | n/a | n/a | <0.03 |
| Docasadienoic | | | |
| C22:4n6 | n/a | n/a | <0.03 |
| Docosatetraenoic | | | |
| C22:5n3 | n/a | n/a | 0.04 |
| Docosapentaenoic | | | |
| C22:6n3 | n/a | 0.06 | 0.03 |
| Docosahexaenoic | | | |
| C24:0 Lignoceric | 0.73 | 0.47 | 0.27 |
| Others | 1.09 | 0.25 | 0.13 |
| Saturates | 48.8 | 50 | 48.8 |
| Monounsaturates | 8.47 | 8.3 | 7.85 |
| Polyunsaturates | 41.4 | 40.9 | 36.7 |
| Trans | 0.16 | 0.72 | 6.64 |
| Omega 3 | 1.45 | 1.51 | 1.36 |
| Omega 6 | 40 | 39.4 | 35.4 |
| Omega 9 | 7.86 | 7.78 | 7.31 |

The most abundant acids are Palmitic acid, Stearic acid, Oleic acid and Linoleic acid. Palmitic acid trends upward from heavy to light while Stearic acid, Oleic acid and Linoleic acid trend downward from heavy to light. The heavy fraction has the least number of fatty acids at 17 and the light has the greatest number of fatty acids at 30. The medium fraction has 27.

Although the present invention has been described and illustrated with respect to preferred embodiments and preferred uses thereof, it is not to be so limited since modifications and changes can be made therein which are within the full, intended scope of the invention as understood by those skilled in the art.

### BIBLIOGRAPHY

1. Muangrat, Rattana & Pongsirikul, Israpong. (2019). Recovery of spent coffee grounds oil using supercritical CO2: extraction optimization and physicochemical properties of oil. CyTA-Journal of Food. 17. 334-346. 10.1080/19476337.2019.1580771.
2. Andrade, Kátia & Gonçalvez, Ricardo & Maraschin, Marcelo & Ribeiro-do-Valle, Rosa & Martinez, Julian & Ferreira, Sandra. (2012). Supercritical fluid extraction from spent coffee grounds and coffee husks: Antioxidant activity and effect of operational variables on extract composition. Talanta. 88. 544-52. 10.1016/j.talanta.2011.11.031.

1. A method of processing coffee grounds, comprising:
drying coffee grounds to at least a predetermined dryness by using a rotatory drier to heat and agitate the coffee grounds while measuring the dryness of the drying coffee grounds; and
mixing the dried coffee grounds with supercritical CO₂ to extract liquid components of the coffee grounds from solid components.

2. The method according to claim 1, wherein the dried coffee grounds contain 5% water or less by weight.

3. The method according to claim 1, wherein the dried coffee grounds contain between 2-5% water by weight.

4. The method according to claim 1, wherein the coffee grounds are dried at a temperature of between 145° F. and 175° F.

5. The method according to claim 1, wherein the rotary drier comprises a rotating drum to contain the coffee grounds.

6. The method according to claim 1, wherein the rotary drier comprises rotating agitators which rotate within a drum configured to contain the coffee grounds.

7. The method according to claim 1, wherein the rotary drier comprises rotating auger which rotate within a drum to agitate and more the drying coffee grounds.

8. The method according to claim 1, wherein the dryness is measured by a humidity sensor mounted in an extraction outlet of the drier.

9. The method according to claim 1, wherein the method comprises sifting the remaining solid coffee grounds to produce coffee grounds flour.

10. The method according to claim 1, wherein the fluid comprises oil, waxes and saponification fluids.

11. The method according to claim 1, wherein the temperature of the supercritical CO₂ is between 31° C. and 160° C.

12. The method according to claim 1, wherein the pressure of the supercritical CO₂ is between 280 and 320 atm.

13. The method according to claim 1, wherein the dryness is measured by measuring the water activity of the grounds.

14. The method according to claim 1, wherein the pressure and temperature of the supercritical CO₂ is adjusted during extraction to extract different fractions of the liquid components at different times.

15. The method according to claim 1, dried coffee grounds are mixed with supercritical CO₂ for between 1-10 hours.

16. The method according to claim 1, wherein the method is performed in batches of between 1-10 kg.

17. The method according to claim 1, wherein the method is performed in batches of between 10-150 kg.

18. The method according to claim 1, wherein the method comprises soaking the dried coffee grounds in liquid CO₂.

19. The method according to claim 1, wherein the method comprises soaking the dried coffee grounds in liquid CO₂ for at least 30 minutes prior to extraction.

20. An apparatus for processing coffee grounds, comprising:
a rotary drier configured to receive coffee grounds, the rotatory drier comprising:
a heater configured to heat the received coffee grounds;
a rotary agitator configured to agitate the received coffee grounds; and
a sensor configured to measure the dryness of the received coffee grounds during drying;
wherein the rotary drier is configured to dry the received coffee grounds to at least a predetermined dryness; and
a supercritical CO₂ extraction assembly comprising:
an extraction vessel configured to receive the dried coffee grounds from the rotary drier;
a source of CO₂;
a heater and a pump configured to condition the CO₂ received from the CO₂ source to be in a supercritical state within the vessel; and
an outlet for extracting liquid components of the coffee grounds from the n extraction vessel.
